(19) United States
(12) Patent Application Publication
(10) Pub. No.: US 2020/0265092 A1
(43) Pub. Date: Aug. 20, 2020

(54) Method and apparatus for the design and optimization of 3D frequency selective surfaces using evolutonary computing techniques

(71) Applicant: The Government of the United States of America as Repesented by the Secretary of the Army, Fort Belvioe, VA (US)

(72) Inventor: Danny Zhiren Zhu, New Windsor, NY (US)

(21) Appl. No.: 16/873,079

(22) Filed: Oct. 31, 2019

Related U.S. Application Data
(60) Provisional application No. 62/750,802, filed on Oct. 25, 2018.

(51) Int. Cl. G06F 16/901; G06F 16/9035; G06F 16/9038; G06F 9/38

(52) U.S. Cl. CPC G06F 16/9024; G06F 16/9035; G06F 9/3897; G06F 9/3836; G06F 16/9038

(57) ABSTRACT

According to one exemplary embodiment, a method for the design and optimization of 3-dimensional Frequency Selective Structures is described. The method may include receiving a plurality of problem instance parameters associated with a pre-defined set of arbitrary three-dimensional contiguous graphs consisting of edges and nodes. The method may include initializing universal system characteristics that govern the behavior of data structures, including a pheromone persistence characteristic and exploration strategy characteristic. The method may also include executing a problem solving iteration, wherein a problem solution is generated for each data structure of the plurality of data structures based on the plurality of characteristics and updating the environment, wherein each environment consists of probabilistically initializing a plurality of data structures wherein each data structure of the plurality of data structures has a plurality of characteristics and wherein the plurality of characteristics includes a design fitness characteristic, a relative pheromone importance characteristic, and a sub-graph representation consisting of at least one place holder node and at least one placeholder node edge, and can form part or all of the edges and nodes of the complete pre-defined graphs as a function of the exploration strategy characteristic, such that at least one node of the plurality of nodes in the graph has an associated mask characteristic and each data structure of the plurality of data structures has a mask characteristic, wherein the problem solution is generated based on the masking requirement associated with adjacent nodes and the masking of the data structure. The method may include determining in each sub-graph when a dynamic path change indicator exists. The method may include initializing sub-graphs based on determining the dynamic path change indicator does not exist, and inserting a placeholder node and at least one placeholder node edge for each sub-graph based on said determination that a dynamic path change indicator does exist. The method may also include selecting the data structures from the sub-graph pool having the highest design fitness solution. The method may include re-initializing an environment with characteristics based on the relative pheromone importance of the selected data structure. The method may include re-initializing the plurality of data structures based on the new environment, for use in a subsequent problem solving iteration.

This application claims the benefit of U.S. Provisional Application No. 62/750,802 filed Oct. 25, 2018, incorporated herein by reference.

### BACKGROUND

The present invention relates generally to the field of computing, and more particularly to combinatorial optimization.

In many real-world scenarios, finding optimal solutions to complex problems through exhaustive searching is not feasible. One real-world scenario, for example, may be determining the optimal way to design a 3 dimensional frequency selective structure. Frequency-selective surfaces (FSSs) have many applications in spatial filtering of electromagnetic waves and are commonly used in antennas, polarizers, radomes, and intelligent architecture. Conventional FSS designs have ranged from canonical shapes and fractal patterns on planar surfaces to miniaturized and multilayer designs, with stable filtering responses up to 50°. Much less work has been done on 3-D FSS designs, which include multi-resonant structures or cavities that offer improved angular stability, with fields of view up to 60°. Recent advances in additive manufacturing techniques have made fully 3-D FSS designs increasingly popular; however, powerful design tools to exploit such fabrication methods are currently unavailable. The optimization problem may not be resolved using standard analytical techniques within practical computational or temporal limits. One alternative to the binary GA that produces contiguous segments is the Ant Colony Optimization algorithm.

### Ant Colony Optimization (ACO)

ACO belongs to the swarm-intelligence family of nature inspired optimization algorithms and is based on ant colonies' ability to collectively forage for food via an indirect communication method known as stigmergy. Stigmergic collaboration occurs between ants when they communicate with one another by modifying their local environment. This is best understood by considering the “double bridge experiment” performed on Argentine ants, where two paths of different lengths are placed between an ant colony and a food source. Initially, since no pheromone concentrations exist nearby, ants randomly pick a path to travel in their forage. As they proceed along the path, they begin depositing pheromones. Future ants are able to detect nearby pheromones and become more likely to follow paths that have higher pheromone concentrations. Over time, the ants converge to almost exclusively using the shorter path, which has become saturated with pheromones, since early ants utilizing this path were able to reach the food source and return to the colony in a shorter amount of time. Based on empirical data gathered from these experiments a mathematical model was developed to describe the likelihood for an ant to pick a particular direction, which served as the basis for modeling the stochastic decision-making process by ants in the first ant colony system.

### Multi-objective Ant Colony Optimization (MO-ACO)

Multi-objective optimization techniques offer an effective way to identify a set of Pareto-optimal or no dominated solutions by exploiting tradeoffs between objectives. Here, solutions are considered nondominated when they match or outperform all other solutions with respect to every objective. The key difference in multi-objective ACO algorithms is in the handling of pheromone information. Construction of ant trails and evaporation of pheromones continues to occur in the same way as traditional ACO. While early implementations of multi-objective ACO were limited to problems in which objectives could be prioritized by importance, a more generalized approach to a bi-objective optimization where no assumptions are made on objective importance has be widely employed. In this approach, objectives are shared across multiple colonies, and pheromone data is individually maintained for each colony and objective. The segment selection probabilities are based on a maximally dispersed set of weights A for each objective, which varies with ant k, kϵ[1, K], according to the following formula:

$${P}_{xyz}^{k} = \frac{{τ}_{xyz}^{λ} \cdot {{τ}^{′}}_{xyz}^{( 1 - λ )}}{{Σ}_{( xyz ) ∈ {N}^{k}} {τ}_{xyz}^{λ} \cdot {{τ}^{′}}_{xyz}^{( 1 - λ )}} .$$

where T_{xyz} and T′_{xyz} represent the pheromone data at wire segment xyz for each objective, and the set of maximally dispersed weight vectors are described by λ(k−1)/(K−1). Thus, for the first ant, λ=0 and only the first objective is used to determine the ant's trail, whereas for the Kₜₕ ant, only pheromone information from the second objective applies. In the objective space, this approach allows each colony to explicitly explore a different region of the Pareto set, based on various tradeoffs between the two objectives' pheromone data. Within each colony, a local non-dominated set of solutions is formed, representing the best ant trails produced by that colony at a particular generation. These solutions are then combined to form a global Pareto set, and ant trails for each solution are evenly distributed across colonies to update their pheromones. This process is repeated until the maximum number of generations has been reached.

### Limitations of Conventional ACO Methods

Although traditional implementations of ACO are ideal for problems like the Traveling Salesman Problem and in the design of MLAs, they offer few advantages in FSS design. This is because ACO is inherently designed to be space filling; that is, the meander travels indefinitely between nodes, never visiting a node twice and terminating only when it becomes trapped. While some amount of space filling is desirable for unit cell miniaturization, a completely space-filled unit cell would result in a solid PEC block and offer no filtering value. Furthermore, since solution construction continues until boundary conditions are met, even when segments are correctly combined to form an optimal design, additional segments will continue to populate resulting in an “overmeandered” design. As a result, geometries consisting only of a subset of segments of fully meandered geometries are inaccessible in the solution space. Unfortunately, changing the meander rules and mitigating this effect requires either a priori knowledge about the effect that an arbitrary 3-D convolution has on a given filtering response, which is not easily predicted, or necessitates multiple function evaluations at each meander-iteration of the current structure's fitness, which is computationally burdensome. Therefore, since it is not possible to intelligently guide the meander in a desirable direction, two novel improvements to traditional ACO implementations are made to constrain the meander instead: adaptive colony masking and the use of lazy ants.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flow chart illustrating the process carried out by a genetic ant colony program according to at least one embodiment;

FIG. 3 is a block diagram of internal and external components of computers and servers depicted in FIG. 1 according to at least one embodiment.

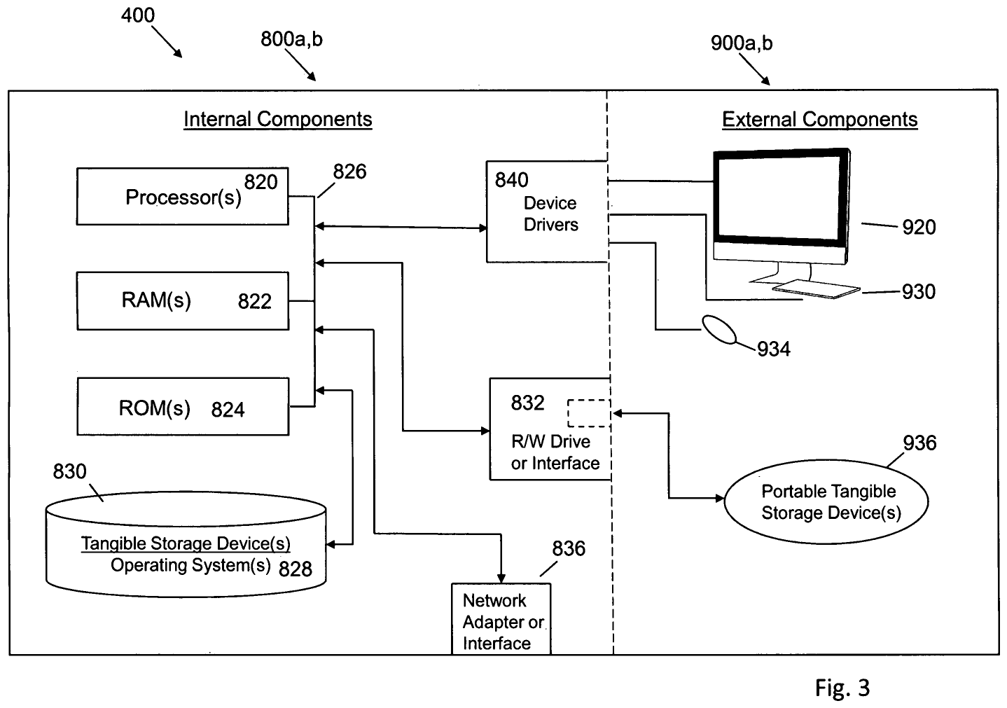

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic, cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for solving vehicle routing problems using evolutionary computing techniques.

As described previously, solving combinatorial optimization problems, such as the capacitated vehicle routing problem, may require alternative analytical techniques, or combinatorial optimizations, to reach a solution within feasible computational and temporal limits. One method for combinatorial optimization mimics ants' food searching behavior (i.e., ant colony optimization). Ant colony optimization describes virtual ants (i.e. agents) that probabilistically choose paths based on a combination of the virtual pheromones deposited by previous ants and heuristics (e.g., path length).

When applied to a graph having nodes and edges, ants in an ant optimization algorithm may choose what node to visit next based on a combination of the pheromone deposits on the edges and the edge weight (e.g., edge length). Ants may be limited to selecting visible nodes (i.e., adjacent nodes having a single edge linking the ant's current node location and the adjacent nodes) as the next node to traverse. Additionally, ants may deposit pheromones along every edge traversed to influence ant decisions in the future. Once an ant colony optimization iteration completes, the pheromone deposit strength is globally reduced on the edges of the graph to account for evaporation. Shorter (i.e., more optimal) paths may have stronger pheromone deposits and thus may be not be effected as much by evaporation as longer (i.e., less optimal) paths. Due to ant bias for choosing paths with stronger pheromone deposits, shorter paths may be favored and traversed by subsequent ants reinforcing optimal paths while evaporation may lessen the probability that non-optimal paths are used. After completing multiple ant colony optimization iterations, ants may rarely deviate from the more optimal path because of the pheromone deposit strength, therefore indicating a possible solution may have been discovered.

Lazy ants represent a significant portion of an ant colony's population and have been shown to be a key component of sustainability in ant colonies with respect to task allocation, with research in swarm intelligence suggesting that lazy ants provide key roles in exploration and sensing. These concepts are heavily leveraged in Multi-objective Lazy Ant Colony Optimization (MOLACO) to increase the diversity of solutions generated in traditional ACO schemes by intelligently constraining space-filling meanders. Since meandering occurs until boundary conditions are met, colony masking works by simply applying constrained boundary conditions, whereas lazy ants introduce a probability of termination to the ant's decision-making process. MOLACO utilizes the same framework as MO-ACO and MMAS, and leverages high performance computing to parallelize colonies as well as ants within each colony.

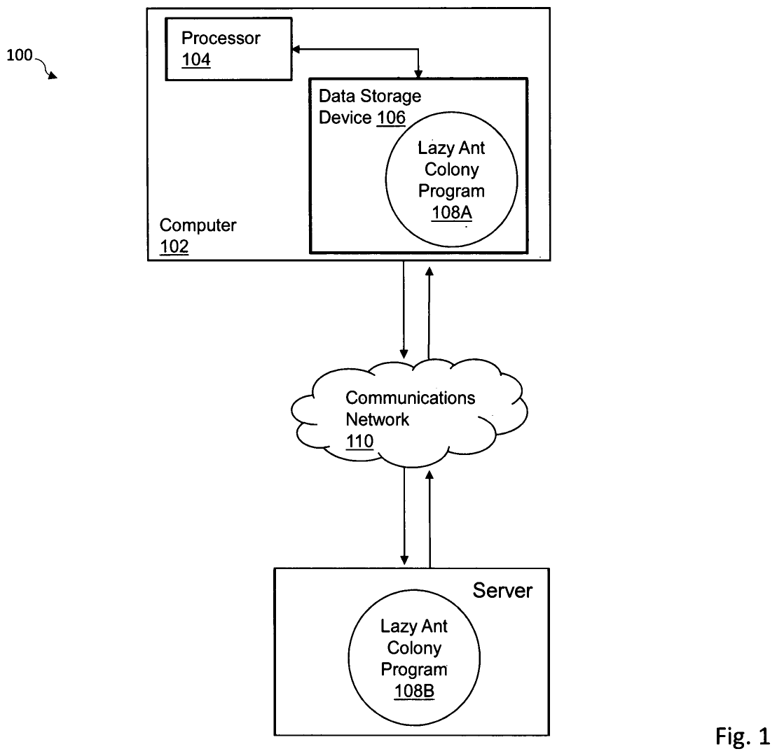

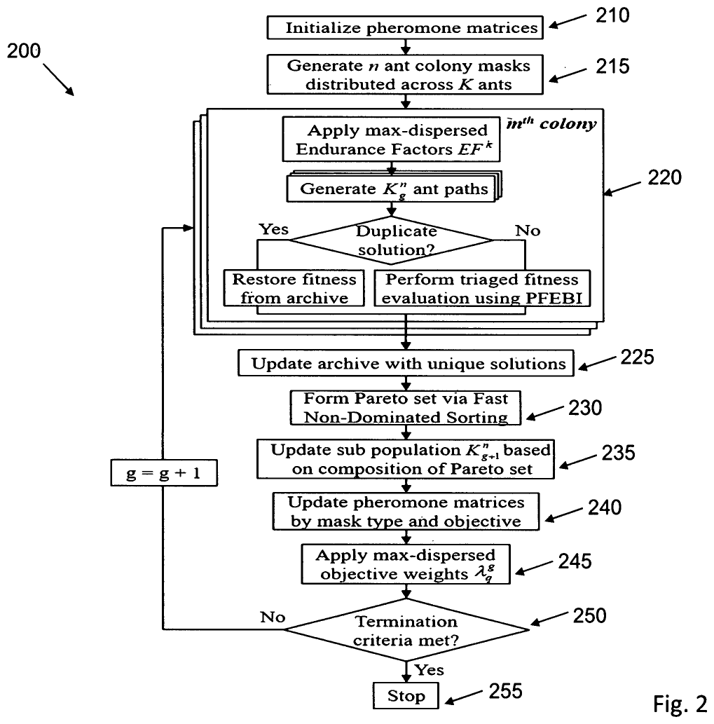

Referring now to FIG. 2, and with continued reference to FIG. 1, an overview of the basic algorithm of an exemplary embodiment for MOLACO is set forth in FIG. 2. The algorithm begins by initializing pheromones to their maximum values 210, and defining a discrete set of n colony “masks;’ 215. This is done by restricting access to certain nodes and choosing starting points such that canonical shapes (i.e., square and circular loops as well as principal and diagonal crosses) will most likely be formed. Each colony is divided into subpopulations of Kn ants 220 that meander according to the boundaries established by these masks with node selection probabilities proportional to the best fitness of each objective thus far. In addition, each ant terminates their movement according to a unique fatigue profile described by an Endurance Factor (EF) EF^{k} which is discussed herein 220. If the solutions have already been previously generated, results are retrieved from the archive. Otherwise, unique geometries undergo an eightfold symmetry operation, are evaluated using an external solver, and assigned a fitness value. While any solver can be used with MOLACO, since FSSs are doubly infinitely periodic structures, a custom fullwave solver that leverages a periodic finite- element boundary integrals (PFEBI) technique is employed, which offers a fast and accurate way to perform full-wave simulations by taking advantage of Floquet boundary conditions. Once all solutions have been calculated, the archive is updated 225 and new solutions are sorted according to Pareto-optimality 230 using a fast nondominated sorting routine. The best Pareto set is then used to update 235 the pheromone matrices for each colony by mask and objective 240. Finally, objective weights are updated 245 by generation according to a maximally dispersed weight Aq and the process is repeated until termination criteria are met 250.

### Adaptive Colony Masking

MOLACO forces exploration of both fully meandered designs and canonical shapes, by allowing subpopulations of ants to traverse colonies only within a masked region. There are two distinct challenges with this approach: choosing the appropriate mask without a priori knowledge that a given geometry is ideal for a specified filtering response and management of pheromones between different masks. Since assigning a single mask to a colony would preclude colonies from collaborating, and hence offer no advantages to multiple single colony optimizations using different masks, colonies are divided into subpopulations and an adaptive population-based masking strategy is employed. In this manner, at each generation, the subpopulation assigned to a given mask increases if the designs outperform other masks, and decreases otherwise, in which the mask population adapts proportionately to the number of solutions in the current Pareto set. Since multiple masks are included in each colony, the management of pheromones becomes more challenging, because pheromone trails for one mask are not applicable to another, due to mismatched boundary conditions. Therefore, it becomes necessary to maintain a separate set of pheromone data for each mask and objective, which maintains cross-collaboration between subpopulations using the same mask across colonies. At the start of the algorithm, a portion of the population remains unmasked, and the remaining members of the population are equally distributed into subpopulation sizes. At the end of each generation, the best-ever Pareto-optimal ant trails for each objective and mask are used to update pheromone trails for their respective mask type in each colony, and the subpopulation sizes are adjusted according to the composition of masks in the Pareto set. Furthermore, to encourage continued exploration, a minimum subpopulation size is enforced, such that no mask is ever completely eliminated from a generation.

### Phantom Termination Segment

While adaptive colony masking by selectively applying start points and boundary conditions encourages exploration of different design geometries, it still does not address the issue of a “runaway” meander. Therefore, the concept of a phantom termination segment is introduced. At a given node within the predefined 3-D wire grid, an ant has up to five available directions along each principle axis (x, y, and z) that it can travel to next, since backtracking from the direction of arrival is not allowed. The phantom termination segment essentially gives the ant a sixth option: cease travel altogether.

The phantom termination segment can serve as a constant probability of termination, or progressively increase, making termination more likely as meander length increases, similar to fatigue. Since termination probability is independent of solution fitness, the termination pheromone is maintained separately from the regular pheromones, and not subject to the constraints imposed by MMAS. To further enhance diversity, a maximally dispersed EF is proposed, similar to the objective weighting scheme used in MO-ACO, described above, ensuring each ant within a colony experiences a different fatigue.

A profile is selected which ensures truncation does not occur until a sufficient number of segments have been populated, and truncation is guaranteed by the time the maximum number of segments 1s exhausted. An appropriate model is then described by the relation:

Fatigue=(I/L)^{EF}exp(v)

where I represents the current number of segments traversed and L represents the maximum number of segments feasible. A good approximation to L can be made based on the mask applied, since L can never exceed the total number of segments allowed by the mask. EF is a measure of how many segments an ant can travel before being exhausted, whereas v is a measure of the maximum termination pheromone that can be accumulated. While EF controls the rate at which fatigue sets in, v controls its overall trajectory.

### Fitness Function

An ideal fitness function is fast, efficient and accurately classifies all designs in the solution space. In order to design an ideal FSS, a given stop/pass filter response must be achieved over the following domains:

1) specified pass/stop frequencies and bandwidths;
2) multiple incidence angles from normal to oblique;
3) both TE and TM incident polarization states.

Thus, for f frequency points of interest, m incidence angles, and two polarization states, at least 2 -m f function evaluations are required per design. This cannot be avoided without sacrificing performance in one or more domains. For a given FSS design, complex co-polarized reflection and transmission coefficients are computed for the domains described above using PFEBI. The fitness associated with a particular frequency band (stop or pass) is then formulated by accumulating the squares of the average squared TE and TM normalized bandwidth at each incidence angle

$${F}_{band} = {\sum }_{n = 1}^{m} {[ \frac{1}{2} ( {FBW}_{TE}^{2} ( {θ}_{n} ) + {FBW}_{TM}^{2} ( {θ}_{n} ) ) ]}^{2}$$

where 0<FBW_{TE/TM}(θₙ)<1 represents the fractional bandwidth (normalized to the desired fractional bandwidth) inclusive of the target frequency f₀ for incidence angle θₙ and TE/TM polarizations according to the formula:

$${FBW}_{TE / TM} = \{ \begin{matrix}\frac{{f}_{max} - {f}_{min}}{{f}_{0}} & {f}_{min} < {f}_{0} < {f}_{max} \\ 0 & otherwise\end{matrix} \}$$

where angle dependence is assumed and fₘᵢₙ and fₘₐₓ are determined based on the following goals: for a stopband, an adequate rejection band is defined as a continuous range over which |S₂₁|<−10dB, whereas an adequate passband corresponds to |S₂₁|>−3dB. In this manner, (7) is calculated for both bands and each value corresponds to an objective in the multiobjective optimization. Since a large number of terms are included in each summation, terms are squared to further emphasize flaws or strengths of each design. However, even with a few sample points in each band, over a large solution space, this quickly becomes computationally expensive.

One approach to minimizing the computation time is by choosing reasonable values for N_{xy} and N_{z} to balance the number of mesh elements (directly proportional to the number of wire segments and therefore the duration of a function evaluation) with the total number of feasible segment combinations. However, even for a reasonably sized geometry, a large design space is still expected, with only a fraction of solutions that satisfy the desired bandwidth, FOV and polarization independence. Therefore, it is equally important to maintain an archive of previous solutions and intelligently triage the fitness function to minimize the number of function evaluations performed. Since angular stability requires consistent performance across a continuous range of incidence angles, it is not necessary to evaluate designs at oblique incidences if they do not have sufficient performance at smaller angles (i.e., angles closer to normal incidence). Triaging function evaluations in this manner drastically reduces computation time spent, quickly separating weaker designs from better ones, while investing more time on designs that show potential. As a result, designs are only rewarded for progressively better performance, which provides a gradient along the fitness surface to guide the optimization algorithm's search. Finally, maintaining an archive of unique solutions allows fitness values to be restored from the archive if duplicate geometries are generated, rather than entirely recalculating them. This is particularly useful for smaller values of Nₓ, N_{y}, and N_{z}, where duplicate geometries are more likely:

In yet another embodiment of the invention the method is employed for the design and optimization of 3-dimensional Frequency Selective Structures includes receiving a plurality of problem instance parameters associated with a pre-defined set of arbitrary three-dimensional contiguous graphs consisting of edges and nodes. The method includes initializing universal system characteristics that govern the behavior of data structures, including a pheromone persistence characteristic and exploration strategy characteristic. In the next method step the process executes a problem solving iteration, wherein a problem solution is generated for each data structure of the plurality of data structures based on the plurality of characteristics and updating the environment. In this example embodiment each environment consists of: probabilistically initializing a plurality of data structures wherein each data structure of the plurality of data structures has a plurality of characteristics and wherein the plurality of characteristics includes a design fitness characteristic, a relative pheromone importance characteristic, and a sub-graph representation consisting of at least one place holder node and at least one placeholder node edge, and can form part or all of the edges and nodes of the complete pre-defined graphs as a function of the exploration strategy characteristic. At least one node of the plurality of nodes in the graph has an associated mask characteristic and each data structure of the plurality of data structures has a mask characteristic, wherein the problem solution is generated based on the masking requirement associated with adjacent nodes and the masking of the data structure. The exemplary method also includes the steps of determining in each sub-graph when a dynamic path change indicator exists and initializing sub-graphs based on determining the dynamic path change indicator does not exist and will insert a placeholder node and at least one placeholder node edge for each sub-graph based on said determination that a dynamic path change indicator does exist. The method also includes the step of selecting the data structures from the sub-graph pool having the highest design fitness solution and the step of re-initializing an environment with characteristics based on the relative pheromone importance of the selected data structure; and re-initializing the plurality of data structures based on the new environment, for use in a subsequent problem solving iteration.

In yet another embodiment the sub-graph pool includes a fatigue characteristic wherein said fatigue characteristic causes the sub-graph iteration to terminate after evaluating more than one but fewer than all of the edges in the graph. Yet another example embodiment of the invention discloses a method for solving combinatorial optimization problems, the method includes receiving a plurality of problem instance parameters associated with a pre-defined set of arbitrary three-dimensional contiguous graphs consisting of edges and nodes and initializing universal system characteristics that govern the behavior of data structures, including a pheromone persistence characteristic and exploration strategy characteristic. This embodiment includes the method step of executing a problem solving iteration, wherein a problem solution is generated for each data structure of the plurality of data structures based on the plurality of characteristics and updating the environment, wherein each environment includes probabilistically initializing a plurality of data structures wherein each data structure of the plurality of data structures has a plurality of characteristics and wherein the plurality of characteristics includes a design fitness characteristic, a relative pheromone importance characteristic, a fatigue characteristic, and a sub-graph representation consisting of at least one place holder node and at least one placeholder node edge, and can form part or all of the edges and nodes of the complete pre-defined graphs as a function of the fatigue and exploration strategy characteristics. This embodiment also includes the method step of determining in each sub-graph when a dynamic path change indicator exists and initializing sub-graphs based on determining the dynamic path change indicator does not exist and inserting a placeholder node and at least one placeholder node edge for each sub-graph based on said determination that a dynamic path change indicator does exist. This embodiment also includes them method step of selecting the data structures from the sub-graph pool having the highest design fitness solution. This embodiment also includes the method step of re-initializing an environment with characteristics based on the relative pheromone importance of the selected data structure; and re-initializing the plurality of data structures based on the new environment, for use in a subsequent problem solving iteration.

In yet another embodiment the graph comprises a plurality of nodes and a plurality of edges, wherein each edge of the plurality of edges links two nodes of the plurality of nodes. In another embodiment of the invention the problem solving iteration generates problem solutions in the form of sub-graphs, wherein each sub-graph comprises selection of adjacent nodes, the adjacent node being linked to a current node by an edge of the plurality of edges, wherein the edge links the current node to the adjacent node, and the problem solving iteration generates a pre-determined number of possible solutions based on environmental characteristics.

In yet another embodiment of the method is employed for the design and optimization of 3-dimensional Frequency Selective Structures the selection of adjacent nodes is based on an edge weight and a pheromone value associated with each edge of the plurality of edges linking the current node with the adjacent node .

In yet another embodiment of the disclosed method for the design and optimization of 3-dimensional Frequency Selective Structures executing the problem solving iteration includes archiving all previously generated solution fitness values and referencing said archived solutions, determining if a new solution has been previously explored, and truncating said problem solving iteration for said data structure if said new solution has been previously explored to reduce redundant computations.

In yet another embodiment the method modifies at least one random characteristic associated with each environment of the plurality of data structures, based on the historical best solution and the exploration strategy characteristic is based on the edge weight associated with each edge in the problem solution. In other embodiments of the disclosed method at least one node of the plurality of nodes in the graph has an associated mask characteristic and each data structure of the plurality of data structures is bounded by said mask characteristics, wherein the problem solution is generated based on the masking requirement associated with adjacent nodes and the masking of the data structure.

In yet another example embodiment of the invention resides in a computer system for solving combinatorial optimization problems. The system includes one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method including receiving a plurality of problem instance parameters associated with a pre-defined set of arbitrary three-dimensional contiguous graphs consisting of edges and nodes and initializing universal system characteristics that govern the behavior of data structures, including a pheromone persistence characteristic and exploration strategy characteristic. The computer system employs processors that are capable of executing a problem solving iteration, wherein a problem solution is generated for each data structure of the plurality of data structures based on the plurality of characteristics and updating the environment, wherein each environment consists of probabilistically initializing a plurality of data structures wherein each data structure of the plurality of data structures has a plurality of characteristics and wherein the plurality of characteristics includes a design fitness characteristic, a relative pheromone importance characteristic, a fatigue characteristic, and a sub-graph representation consisting of at least one place holder node and at least one placeholder node edge, and can form part or all of the edges and nodes of the complete pre-defined graphs as a function of the fatigue and exploration strategy characteristics. The computer system employs processors that are capable of determining in each sub-graph when a dynamic path change indicator exists, initializing sub-graphs based on the determining the dynamic path change indicator does not exist and inserting a placeholder node and at least one placeholder node edge for each sub-graph based on said determination that a dynamic path change indicator does exist. The computer system employs processors that are capable of selecting the data structures from the sub-graph pool having the highest design fitness solution; re-initializing an environment with characteristics based on the relative pheromone importance of the selected data structure; and re-initializing the plurality of data structures based on the new environment, for use in a subsequent problem solving iteration.

In this example embodiment the computer system the graph comprises a plurality of nodes and a plurality of edges, wherein each edge of the plurality of edges links two nodes of the plurality of nodes. In this embodiment the problem solving iteration generates problem solutions as sub-graphs, wherein each sub-graph comprises selection of adjacent nodes, the adjacent node being linked to a current node by an edge of the plurality of edges, wherein the edge links the current node to the adjacent node, and wherein the problem solving iteration generates a pre-determined number of possible solutions based on environmental characteristics and selection of adjacent nodes is based on an edge weight and a pheromone value associated with each edge of the plurality of edges linking the current node with the adjacent node.

The computer system employs processors that archive and reference all archived solution fitness values to expedite arrival at a feasible solution by preventing redundant computation of previously explored solutions and modifies at least one random characteristic associated with each environment of the plurality of newly generated data structures, based on the historical best solution.

In yet another example embodiment the invention resides in a computer program product for solving combinatorial optimization problems, comprising: one or more computer-readable storage medium and program instructions stored on at least one of the one or more tangible storage medium, the program instructions executable by a processor, the program instructions including program instructions to receive a plurality of problem instance parameters associated with a pre-defined set of arbitrary three-dimensional contiguous graphs consisting of edges and nodes. The computer program product includes program instructions to initialize universal system characteristics that govern the behavior of data structures, including a pheromone persistence characteristic and exploration strategy characteristic and program instructions to execute a problem solving iteration, wherein a problem solution is generated for each data structure of the plurality of data structures based on the plurality of characteristics and updating the environment, wherein each environment consists of: program instructions to initialize a plurality of data structures wherein each data structure of the plurality of data structures has a plurality of characteristics and wherein the plurality of characteristics includes a design fitness characteristic, a relative pheromone importance characteristic, a fatigue characteristic, and a sub-graph representation consisting of at least one place holder node and at least one placeholder node edge, and can form part or all of the edges and nodes of the complete pre-defined graphs as a function of the fatigue and exploration strategy characteristics and program instructions to determine in each sub-graph when a dynamic path change indicator exists. The computer program product also includes program instructions to initialize sub-graphs based on the determining the dynamic path change indicator does not exist and program instructions to insert a placeholder node and at least one placeholder node edge for each sub-graph based on said determination that a dynamic path change indicator does exist as well as program instructions to select the data structures from the sub-graph pool having the highest design fitness solution; program instructions to re-initialize an environment with characteristics based on the relative pheromone importance of the selected data structure; and program instructions to re-initialize the plurality of data structures based on the new environment, for use in a subsequent problem solving iteration.

In yet another embodiment of the computer program product the graph comprises a plurality of nodes and a plurality of edges, wherein each edge of the plurality of edges links two nodes of the plurality of nodes.

In yet another embodiment of the computer program product the problem solving iteration generates problem solutions as sub-graphs, wherein each sub-graph comprises selection of adjacent nodes, the adjacent node being linked to a current node by an edge of the plurality of edges, wherein the edge links the current node to the adjacent node, and wherein the problem solving iteration generates a pre-determined number of possible solutions based on environmental characteristics.

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) may include respective sets of internal components 800a, b and external components 900a, b illustrated in FIG. 4. Each of the sets of internal components 800a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs such as a GACH program 108A and 108B (FIG. 1) corresponding to process 200 (FIG. 2), may be stored on one or more computer-readable tangible storage devices 830 for execution by one or more processors 820 via one or more RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 s a semiconductor storage device such as ROM 824, EPROM, flash memory or any other computer-readable tangible storage device that can store a computer program and digital information.

Each set of internal components 800a, b also includes a RNV drive or interface 832 to read from and write to one or more portable computer-readable tangible storage devices 936 such as a CD-ROM, DVD, memory stick, magnetic tape, magnetic disk, optical disk or semiconductor storage device. The GACH program 108A and 108B (FIG. 1) can be stored on one or more of the respective portable computer-readable tangible storage devices 936, read via the respective RNV drive or interface 832 and loaded into the respective hard drive 830.

Each set of internal components 800a, b may also include network adapters (or switch port cards) or interfaces 836 such as a TCP/IP adapter cards, wireless wi-fi interface cards, or 3G or 4G wireless interface cards or other wired or wireless communication links. The GACH program 108A (FIG. 1) in client computer 102 (FIG. 1) and the GACH program 108B (FIG. 1) in network server computer 112 (FIG. 1) can be downloaded from an external computer (e.g., server) via a network (for example, the Internet, a local area network or other, wide area network) and respective network adapters or interfaces 836. From the network adapters (or switch port adaptors) or interfaces 836, the GACH program 108A (FIG. 1) in client computer 102 (FIG. 1) and the GACH program 108B (FIG. 1) in network server computer 112 (FIG. 1) are loaded into the respective hard drive 830. The network may comprise copper wires, optical fibers, wireless transmission, routers, firewalls, switches, gateway computers and/or edge servers.

Each of the sets of external components 900a, b can include a computer display monitor 920, a keyboard 930, and a computer mouse 934. External components 900a, b can also include touch screens, virtual keyboards, touch pads, pointing devices, and other human interface devices. Each of the sets of internal components 800a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended o be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A method for the design and optimization of 3-dimensional Frequency Selective Structures, the method comprising:
receiving a plurality of problem instance parameters associated with a pre-defined set of arbitrary three-dimensional contiguous graphs consisting of edges and nodes;
initializing universal system characteristics that govern the behavior of data structures, including a pheromone persistence characteristic and exploration strategy characteristic;
executing a problem solving iteration, wherein a problem solution is generated for each data structure of the plurality of data structures based on the plurality of characteristics and updating the environment, wherein each environment consists of:
probabilistically initializing a plurality of data structures wherein each data structure of the plurality of data structures has a plurality of characteristics and wherein the plurality of characteristics includes a design fitness characteristic, a relative pheromone importance characteristic, and a sub-graph representation consisting of at least one place holder node and at least one placeholder node edge, and can form part or all of the edges and nodes of the complete pre-defined graphs as a function of the exploration strategy characteristic;
wherein at least one node of the plurality of nodes in the graph has an associated mask characteristic and each data structure of the plurality of data structures has a mask characteristic, wherein the problem solution is generated based on the masking requirement associated with adjacent nodes and the masking of the data structure;
determining in each sub-graph when a dynamic path change indicator exists;
initializing sub-graphs based on determining the dynamic path change indicator does not exist;
inserting a placeholder node and at least one placeholder node edge for each sub-graph based on said determination that a dynamic path change indicator does exist;
selecting the data structures from the sub-graph pool having the highest design fitness solution;
re-initializing an environment with characteristics based on the relative pheromone importance of the selected data structure; and
re-initializing the plurality of data structures based on the new environment, for use in a subsequent problem solving iteration.

2. The method of claim 1 wherein the sub-graph pool includes a fatigue characteristic wherein said fatigue characteristic causes the sub-graph iteration to terminate after evaluating more than one but fewer than all of the edges in the graph.

3. A method for solving combinatorial optimization problems, the method comprising:
receiving a plurality of problem instance parameters associated with a pre-defined set of arbitrary three-dimensional contiguous graphs consisting of edges and nodes;
initializing universal system characteristics that govern the behavior of data structures, including a pheromone persistence characteristic and exploration strategy characteristic;
executing a problem solving iteration, wherein a problem solution is generated for each data structure of the plurality of data structures based on the plurality of characteristics and updating the environment, wherein each environment consists of:
probabilistically initializing a plurality of data structures wherein each data structure of the plurality of data structures has a plurality of characteristics and wherein the plurality of characteristics includes a design fitness characteristic, a relative pheromone importance characteristic, a fatigue characteristic, and a sub-graph representation consisting of at least one place holder node and at least one placeholder node edge, and can form part or all of the edges and nodes of the complete pre-defined graphs as a function of the fatigue and exploration strategy characteristics;
determining in each sub-graph when a dynamic path change indicator exists;
initializing sub-graphs based on determining the dynamic path change indicator does not exist;
inserting a placeholder node and at least one placeholder node edge for each sub-graph based on said determination that a dynamic path change indicator does exist;
selecting the data structures from the sub-graph pool having the highest design fitness solution;
re-initializing an environment with characteristics based on the relative pheromone importance of the selected data structure; and
re-initializing the plurality of data structures based on the new environment, for use in a subsequent problem solving iteration.

4. The method of claim 3 wherein the graph comprises a plurality of nodes and a plurality of edges, wherein each edge of the plurality of edges links two nodes of the plurality of nodes.

5. The method of claim 4, wherein the problem solving iteration generates problem solutions in the form of sub-graphs, wherein each sub-graph comprises selection of adjacent nodes, the adjacent node being linked to a current node by an edge of the plurality of edges, wherein the edge links the current node to the adjacent node, and wherein the problem solving iteration generates a pre-determined number of possible solutions based on environmental characteristics.

6. The method of claim 5, wherein the selection of adjacent nodes is based on an edge weight and a pheromone value associated with each edge of the plurality of edges linking the current node with the adjacent node.

7. The method of claim 3, wherein executing a problem solving iteration comprises archiving all previously generated solution fitness values.

8. The method of claim 7 wherein executing a problem solving iteration comprises referencing said archived solutions, determining if a new solution has been previously explored, and truncating said problem solving iteration for said data structure if said new solution has been previously explored to reduce redundant computations.

9. The method of claim 3, further comprising: modifying at least one random characteristic associated with each environment of the plurality of data structures, based on the historical best solution.

10. The method of claim 6, wherein the exploration strategy characteristic is based on the edge weight associated with each edge in the problem solution.

11. The method of claim 5, wherein at least one node of the plurality of nodes in the graph has an associated mask characteristic and each data structure of the plurality of data structures is bounded by said mask characteristics, wherein the problem solution is generated based on the masking requirement associated with adjacent nodes and the masking of the data structure.

12. A computer system for solving combinatorial optimization problems, comprising: one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a plurality of problem instance parameters associated with a pre-defined set of arbitrary three-dimensional contiguous graphs consisting of edges and nodes;
initializing universal system characteristics that govern the behavior of data structures, including a pheromone persistence characteristic and exploration strategy characteristic;
executing a problem solving iteration, wherein a problem solution is generated for each data structure of the plurality of data structures based on the plurality of characteristics and updating the environment, wherein each environment consists of:
probabilistically initializing a plurality of data structures wherein each data structure of the plurality of data structures has a plurality of characteristics and wherein the plurality of characteristics includes a design fitness characteristic, a relative pheromone importance characteristic, a fatigue characteristic, and a sub-graph representation consisting of at least one place holder node and at least one placeholder node edge, and can form part or all of the edges and nodes of the complete pre-defined graphs as a function of the fatigue and exploration strategy characteristics;
determining in each sub-graph when a dynamic path change indicator exists;
initializing sub-graphs based on the determining the dynamic path change indicator does not exist;
inserting a placeholder node and at least one placeholder node edge for each sub-graph based on said determination that a dynamic path change indicator does exist;
selecting the data structures from the sub-graph pool having the highest design fitness solution;
re-initializing an environment with characteristics based on the relative pheromone importance of the selected data structure; and
re-initializing the plurality of data structures based on the new environment, for use in a subsequent problem solving iteration.

13. The computer system of claim 12, wherein the graph comprises a plurality of nodes and a plurality of edges, wherein each edge of the plurality of edges links two nodes of the plurality of nodes.

14. The computer system of claim 13, wherein said problem solving iteration generates problem solutions as sub-graphs, wherein each sub-graph comprises selection of adjacent nodes, the adjacent node being linked to a current node by an edge of the plurality of edges, wherein the edge links the current node to the adjacent node, and wherein the problem solving iteration generates a pre-determined number of possible solutions based on environmental characteristics.

15. The computer system of claim 14, wherein the selection of adjacent nodes is based on an edge weight and a pheromone value associated with each edge of the plurality of edges linking the current node with the adjacent node.

16. The computer system of claim 12, wherein all solution fitness values are archived and are referenced to expedite arrival at a feasible solution by preventing redundant computation of previously explored solutions.

17. The computer system of claim 12, further comprising: modifying at least one random characteristic associated with each environment of the plurality of newly generated data structures, based on the historical best solution.

18. A computer program product for solving combinatorial optimization problems, comprising: one or more computer-readable storage medium and program instructions stored on at least one of the one or more tangible storage medium, the program instructions executable by a processor, the program instructions comprising:
program instructions to receive a plurality of problem instance parameters associated with a pre-defined set of arbitrary three-dimensional contiguous graphs consisting of edges and nodes;
program instructions to initialize universal system characteristics that govern the behavior of data structures, including a pheromone persistence characteristic and exploration strategy characteristic;
program instructions to execute a problem solving iteration, wherein a problem solution is generated for each data structure of the plurality of data structures based on the plurality of characteristics and updating the environment, wherein each environment consists of:
program instructions to initialize a plurality of data structures wherein each data structure of the plurality of data structures has a plurality of characteristics and wherein the plurality of characteristics includes a design fitness characteristic, a relative pheromone importance characteristic, a fatigue characteristic, and a sub-graph representation consisting of at least one place holder node and at least one placeholder node edge, and can form part or all of the edges and nodes of the complete pre-defined graphs as a function of the fatigue and exploration strategy characteristics;
program instructions to determine in each sub-graph when a dynamic path change indicator exists;
program instructions to initialize sub-graphs based on the determining the dynamic path change indicator does not exist;
program instructions to insert a placeholder node and at least one placeholder node edge for each sub-graph based on said determination that a dynamic path change indicator does exist;
program instructions to select the data structures from the sub-graph pool having the highest design fitness solution;
program instructions to re-initialize an environment with characteristics based on the relative pheromone importance of the selected data structure; and
program instructions to re-initialize the plurality of data structures based on the new environment, for use in a subsequent problem solving iteration.

19. The computer program product of claim 18, wherein the graph comprises a plurality of nodes and a plurality of edges, wherein each edge of the plurality of edges links two nodes of the plurality of nodes.

20. The computer program product of claim 19, wherein the problem solving iteration generates problem solutions as sub-graphs, wherein each sub-graph comprises selection of adjacent nodes, the adjacent node being linked to a current node by an edge of the plurality of edges, wherein the edge links the current node to the adjacent node, and wherein the problem solving iteration generates a pre-determined number of possible solutions based on environmental characteristics.
